(19) United States
(12) Patent Application Publication
(10) Pub. No.: US 2004/0087680 A1
(43) Pub. Date: May 6, 2004

(54) Waterborne ophthalmic lens ink

(75) Inventor: Martin L. Hage, Maple Grove, MN (US)

Correspondence Address: INSKEEP INTELLECTUAL PROPERTY GROUP, INC., 1225 W. 190th Street, Gardena, CA, 90248, US

(73) Assignee: Vision-Ease Lens, Inc.

(21) Appl. No.: 10/635,812

(22) Filed: Aug. 5, 2003

Related U.S. Application Data
(60) Provisional application No. 60/401,264, filed on Aug. 5, 2002.

(51) Int. Cl. C03C 17/00; C09D 5/00

(52) U.S. Cl. 523/160; 523/161

(57) ABSTRACT

This patent application discloses a waterborne ink for printing marks on ophthalmic lenses, and a process for applying the ink to various coated or uncoated surfaces, especially the surfaces of polycarbonate lenses. The ink produces marks that are free of any ghost images after the removal of the ink. The ink includes preferably an acrylic polymer, a coloring agent, and preferably further includes at least one surfactant as a wetting agent.

### BACKGROUND OF THE INVENTION

### RELATED APPLICATIONS

This application claims priority to provisional application Serial No. 60/401,264 filed Aug. 5, 2002, the entire contents of which is incorporated herein by reference.

### BACKGROUND OF THE INVENTION

This invention relates to the formula of a waterborne lens ink that is suitable for marking ophthalmic lenses. This invention also relates to the process that is used to apply the waterborne ink to ophthalmic lenses of various coated or uncoated materials, especially polycarbonate. Furthermore, this invention also relates to an ophthalmic lens article that has had such an ink applied to it. The ink is useful for various purposes, including, but not limited to, making such things as progressive markings, identifying the axis of polarization, designating the cylinder axis, and marking with a brand name, trade mark, or logo.

Progressive addition ophthalmic lenses are generally stamped or printed with progressive marks to identify the measuring positions for far and near distances, fitting cross, major reference point, and axis lines. Other types of lenses may also be printed with special markings to aid in aligning the lenses during surfacing and fitting into the wearer's frames. For example, polarized lenses may be printed with a mark to show the axis of polarization.

Historically, solventborne inks have been used to print various markings on ophthalmic lenses. However, solventborne inks have had numerous inherent disadvantages, including high cost, strong objectionable odors, high flammability, strong solvents are required for cleaning, toxicity, environmental concerns, and an ever present risk of ghosting, which is perhaps the most significant disadvantage of solventborne inks. The ghost image is due to the residue or remains of the printed image after the removal of the ink, which ghost image becomes most noticeably visible after tinting or putting the lens through cleaning equipment that is commonly used to prepare the lenses before applying an antireflective coating. This ghost image results from the inability to completely remove the solventborne ink because the ink has penetrated the lens, becoming absorbed and embedded due to the strong solvents that are present in the ink. In addition, some solventborne inks that are sold for lens markings are also very expensive, and are very difficult to remove by means that are acceptable to the surfacing laboratories or other customers of ophthalmic lenses who put the lenses into spectacle frames or otherwise prepare the lenses for the wearer.

Yet, some other commercially used solventborne inks have poor adhesion to the lens surface. Poor adhesion may result in a loss of the printed marking from the lens during handling in the manufacturing facilities, the surfacing laboratories, or the optical dispensaries.

Thus, there is a need for an ophthalmic lens marking ink that will provide an adequate level of adhesion for lens handling, yet be easy to remove after the lenses are edged for a given spectacle frame, and also eliminate any potential of a ghost image after the marking has been removed. It is found by the inventor that an acrylic latex based waterborne ink can satisfy the above requirements, but also provide additional advantages such as lower cost, decreased flammability, reduced toxicity, minimized odors, faster dry, less smudging, greater line speed, and easier cleanup.

### OBJECTS AND SUMMARY OF THE INVENTION

It is, therefore, one objective of the present invention to provide an ophthalmic lens marking ink for printing a mark on a surface of a lens, eliminating any potential for a ghost image, having adequate adhesion, and being easy to remove, along having other advantages.

It is another objective of the present invention to provide a process that is used to apply the inventive ink to ophthalmic lenses.

The first objective is achieved by careful formulation of a waterborne ink, which comprises an acrylic or other water reducible polymer, water, a coloring agent, and a surfactant. There may exist other components in the formulation for special purposes.

The second objective is achieved by employing a pad printing process comprising washing the lens with one or more aqueous media, drying with warm air, and pad printing the ink to form a mark on the lens.

It should be noted that the term “mark” or “marking” as used in the present invention is meant to include any image and any character as well as any identifying indicia such as a trademark or logo.

In one preferred embodiment, an ophthalmic lens marking ink comprises, by weight, about 85% to about 97% latex vehicle, less than about 10% surfactant, and less than about 5% coupling tail solvent. The latex vehicle may be formed by the emulsion polymerization of (meth)acrylic acid esters of C1 to C10 alcohol and, optionally, substituted or unsubstituted styrene.

The use of the inventive ink over the commercially available solventborne inks, in conjunction with the process of the present invention, offers numerous advantages, including lower cost, decreased flammability, reduced toxicity, minimized odors, faster dry, less smudging, greater line speed, easier cleanup, greater adhesion, and the elimination of any potential for ghosting.

These as well as other objects, features, and attendant advantages of the present invention will be more fully appreciated from the reading of the following detailed description.

### DETAILED DESCRIPTION OF THE INVENTION

According to the first aspect of the present invention, an ink is provided for printing a mark such as a progressive marking or a character on a surface of a lens. The ink may be formulated from a water reducible polymer, resin, vehicle, or binder that may form a solution, dispersion, or an emulsion when combined with water. The ink in accordance with the invention is composed of a waterborne vehicle and one or more colorants. The vehicle includes the dispersion or emulsion of one or more polymeric binders in water, a surfactant, a coupling tail solvent, and other functional components. Latex emulsions and dispersions are preferred by virtue of their usual tendency to dry to a set to touch state more rapidly than aqueous solutions. Nonlimiting examples include acrylic lattices, styrenated acrylic lattices, acrylic solutions, polyester dispersions, alkyd dispersions, alkyd emulsions, epoxy emulsions, vinyl emulsions and polyurethane dispersions. Nonoxidative drying polymers may be used as the binder in the vehicle provided they do not crosslink extensively, which would impair their removability by dissolution.

Styrenated acrylic lattices are generally preferred by virtue of their very good combination of properties that are particularly well suited for this application, including low cost, rapid dry, good adhesion, pigment grinding ease, ready availability, and ease of removal by acetone, alkaline aqueous media, or low molecular weight alcohols, such as 2-propanol.

A styrenated acrylic latex is formed by the emulsion polymerization of a styrene monomer, including styrene and substituted styrenes, or mixtures thereof, and an acrylic or methacrylic acid ester of C1 to C10 alcohol, or a mixture thereof. Substituted styrenes include alkyl substituted styrenes, halogen substituted styrenes, and the like. Examples of suitable alkyl acrylic monomers include, but are not limited to, ethyl acrylate, propyl acrylate, butyl acrylate, octyl acrylate, ethylhexyl acrylate, and the like. In a preferred embodiment, the latex binder is formed from at least about 50%, by weight, of the (meth)acrylate monomer, and more preferably comprises at least about 75% of the (meth)acrylate monomer, based on the total weight of the (meth)acrylate and styrene monomers. In a preferred embodiment, acrylic acid, methacrylic acid, or mixtures thereof as well as their corresponding salts may be used to provide the desired water reducibility and solution stability. The ammonium, potassium, and sodium salts or mixtures thereof are particularly preferred. Likewise, hydroxyethyl acrylate, hydroxyethyl methacrylate, hydroxypropyl acrylate, hydroxypropyl methacrylate, and mixtures thereof may also be used to provide the desired water reducibility or solution stability.

The emulsion polymerization for preparing the latex binder may employ a charge stabilizing emulsifier, a steric stabilizing emulsifier, or both, in order to obtain adequate solution stability and the desired particle size. Particularly, the latex binder has an average particle size from about 150 nm to about 350 nm, and more preferably from about 200 nm to about 300 nm, and most preferably from about 250 nm to about 280 nm. The emulsifier is also useful in controlling the surface energy of the latex binder so that the latex will have a proper wetting, film formation behavior, and resolubility. Various emulsifiers may be used such as are commonly employed for emulsion polymerization, including, but not limited to a fatty acid ether sulfate. The emulsifier may be employed in conventional amounts and preferably in an amount of from about 0.1% to about 5.0% by weight of the emulsion polymerization components.

The emulsion or solution polymerization may be initiated by a peroxide, a persulfate, an azonitrile, or any other free radical initiator known in the art. Preferably, the initiator comprises a compound such as a peroxide, a persulfate, or the like. Persulfate initiators such as ammonium persulfate are particularly preferred in the case of an emulsion polymerization. The initiator may be employed in an amount of from about 0.1 to about 5.0 weight percent, based on the total weight of the polymerization components.

A latex or emulsion may contain conventional amount of polymeric binders as made during emulsion polymerization process. The amount of binders is preferably from about 30% to 70% more preferably from 40% to 60%, by weight, in the latex emulsion. Example styrenated acrylic emulsions include Hydro-Rez 3110, 3400 and 4100 from Eastman Chemicals, TN.

The vehicle of the waterborne ink composition of the present invention may also contain other additives such as surfactants, transfer aids, or thixotropic agents. A surfactant is used to improve the wetting of the ink on the substrate surface. Nonionic surfactants such as the acetylenic alcohols, whether monohydric or dihydric, such as those that are available from Air Products and Chemicals of Allentown, Pa., and perfluorinated surfactants are especially desired. Examples of perfluorinated surfactants include FC-430 from 3M, MN, Zonyl FS0-100 from DuPont, Bayouet FT 719 from Bayer and Polyfox 636 fro Omnova. The surfactants may be employed in conventional amounts and preferably in an amount of from about 0.1% to about 10.0% by weight, and more preferably 5.0% by weight, based upon the vehicle composition.

A further component of the vehicle of waterborne ophthalmic lens ink compositions is the low volatility coupling tail solvent, such as ethylene glycol, propylene glycol, or their derivatives such as ethers, esters, and oligomers. The purpose of the coupling tail solvent include reducing the drying rate of the ink to increase the adhesion and improve the print quality of the ink, both of which are adversely affected due to a loss of homogeneity as the composition of the ink changes on drying. A coupling tail solvent may be employed in conventional amounts and preferably in an amount of from about 1% to about 30% by weight, based upon the vehicle composition.

Other examples of suitable tail solvents include, but are not limited to 2-butoxyethanol, 2-(2-butoxyethoxy)ethanol, glycerin, 1,3-propanediol, 1,5-pentanediol, diethylene glycol, polyethylene glycol, dipropylene glycol, polypropylene glycol, tetramethylene glycol, pyrrolidinones such as 1-methyl-2-pyrrolidinone, and mixtures thereof. In a preferred embodiment, the tail solvent comprises propylene glycol or 2-butoxyethanol.

A wide variety of coloring agents such as pigments, dyes, or other colorants may be used alone or in combination in the ink compositions of the present invention. Pigments that are suitable for use in the present ink compositions include, but are not limited to, titanium oxides, chromates, zinc oxides, iron oxides, and carbon black. Dyes that are suitable for use in the present ink compositions include, but are not limited to, condensed azo dyes, chelate azo dyes, phthalocyanines, anthraquinones, quinacridones, thioindigoids, isoindolinones, quinophthalones, and nitro dyes. Preferred colors are white, red, blue, yellow, green, and black. Titanium dioxide is specially preferred by virtue of the brightness, whiteness, opacity, and hiding power that it possesses, which are important for the use of an automatic inspection system. Other colors may be used for trade names, company names, trademarks, logos, and other forms of branding.

The pigment dispersion particles must be sufficiently small to permit free flow. The particle size of the pigment should also be selected to maintain pigment dispersion stability in the ink, and it is generally desirable to use smaller sized particles for maximum cost effectiveness, color strength, and stability against settling. Accordingly, pigment dispersion particles having a size in the range of from about 50 nm to about 500 nm, and more preferably less than about 200 nm, are preferred. The amount of the coloring agent in the ink is determined by factors such as the thickness of a marking to be printed and the desired chroma. The amount of coloring agent is preferably between 1% to 30% by weight, more preferably between 3% to 25% by weight. When the coloring agent content is more than 30%, the adherence of the ink to the lens may be reduced.

According to the second aspect of the present invention, there is provided a process to apply the inventive waterborne ink to a lens surface. The process comprises the steps of cleaning the lens surface, drying the lens surface, optionally treating the lens surface, applying the ink on the lens surface, and drying the ink to secure it to the lens surface.

The process of the present invention may be described as follows. To improve the performance of the ink and improve the quality of the printed image, the lenses are washed using one or more aqueous media, which are preferably warm to facilitate drying. The aqueous cleaning solutions will usually contain anionic surfactants, nonionic surfactants, cationic surfactants, amphoteric surfactants, low molecular weight glycol ethers, or mixtures thereof. Using an air knife, the lenses are then dried with warm air of low relative humidity. Precautions are taken to avoid anything from coming into contact with the cleaned lenses. The lenses are printed as soon as possible after cleaning to prevent dirt, debris, or other soiling materials from becoming attached to the lens, which would have a deleterious effect on the performance of the ink as well as the printed image. Typically, but not exclusively, the ink will be applied using a pad comprised of silicone rubber or other elastomeric material to ensure good print quality and accurate reproduction of the desired mark or image. After printing, the lenses are allowed to dry for a few minutes prior to inspection of the print with an automated inspection system to verify print quality and registration or print position. The lenses are then packaged before being placed in the warehouse inventory prior to sale and distribution.

To improve the print quality, flow and leveling of the ink, as well as increase the adhesion of the ink, the lens surface may be optionally treated with various methods known to the art. Such methods include, but are not limited to, corona discharge, plasma etching, chemical etching, flame treatment, and short-wavelength (<260 nm) UV irradiating.

Regardless of what ink is used, the use of corona to treat the lens surface has been shown to be beneficial for ink adhesion without deleterious side effects such as a loss of abrasion resistance, yellowing, the development of any haze, or a change in tintability. The corona treatment serves to increase the surface energy of the lens coating by oxidizing the skin oils, machine lubricants, coating surfactants, and other low surface energy coating additives that bloom, migrate, exude, or otherwise get onto the lens surface. The corona treatment enhances the wetting, flow, and leveling of the ink, which in turn results in improved ink transfer, print quality, as well as adhesion of the ink to the lens surface. Corona treating equipment, such as the Multidyne equipment available from Softal 3DT of Germantown, Wis., may be successfully used to treat lenses. An alternating current of about 60 hertz at about 24,000 volts in air with a gap of approximately 0.25 inches between the electrodes has been found to provide adequate treatment if the lenses are treated for about ten seconds with the treating head positioned about one inch away from the surface of the lens. The lenses may be treated while fixed in a stationary position or, alternatively, the lenses may be treated while moving on a conveyor system. Corona treatment using gases other than air are also suitable for improving the cosmetic quality as well as the adhesion of the applied ink.

In the printing step, the ink is applied to the cleaned and optionally treated lens surface preferably by the pad printing technique, which typically comprises the steps of filling an ink into a recess in the shape of the desired mark in a printing plate or cliche, removing the excess ink from the printing plate, pressing a pad against the recess to transfer the ink from the printing plate to the pad, and pressing the pad against the lens surface to transfer the ink from the pad to the surface of the lens to form the shape of the desired mark on the surface of the lens. Such a pad printing technique is suitable for printing a mark on a lens surface because the rubber pad is able to conform to the curved shape of the lens surface. The ink of the invention has a superior transferability and hence is suited for the pad printing process by which the lens marking ink is transferred from the engraved printing plate to the cleaned lens surface by the pad. A model PI/290-A2 from Printing International or a model Seal Cup 90 from Trans Tech America can be used to perform the pad printing.

After printing, the ink is briefly dried for a few minutes at a temperature in the range of ambient to 160° F. For both progressive addition lens as well as polarized lens types, following the printing and drying stages it is possible to have an automated system to inspect the correctness of the marking positions. For best results, this automated system is incorporated inside the pad printing machine to align the lens in the correct position.

The present invention will now be described in more detail in reference to examples, which are for illustration purposes only and should not in any way be construed as a limitation upon the scope of the invention.

### EXAMPLE

A polycarbonate progressive lens is washed with an aqueous detergent solution at 125F containing 1.0 percent by weight anionic detergent in water. The lens is dried using air knives in conjunction with forced warm air. The lens is then treated with corona discharge from a Multidyne corona treating unit from Softal 3DT. Using a model PI/290-A2 pad printing machine from Printing International, a Type G solventborne acrylic ink from Trans Tech America was then applied to the lens surface to provide the progressive marking.

The result is a printed image with very good print quality that is readable by automated inspection equipment. However, the adhesion is very poor as some of the printed image is lost on subsequent processing and handling. The ink fails adhesion as the printed image is readily removed by the protective tape that is applied to the lens prior to blocking and surfacing to prescription.

Optionally, after drying the printed image for an hour at room temperature, the lens can be placed into an oven at 200° F. for six hours to enhance the adhesion of the ink. However, this too is undesirable due to the increase in capital equipment, process time, and energy costs. Furthermore, this two hour baking step results in the ink becoming much more insoluble in 2-propanol and the other less hazardous solvents that are preferred for the purpose of removing this ink. This makes the ink much more difficult to remove resulting in additional process time, labor costs, and an increased risk of scratching the lens as much greater pressure is applied when wiping the lens to remove the ink. Finally, and perhaps most importantly, the two hour baking step results in moderate to severe ghosting, which is particularly visible after the lens has been tinted.

### Example 1

An example of one such useful ink is as follows, where the following percentages are by weight:

94% Mallaflex 2268 dispersion of titanium dioxide in a styrenated acrylic latex (Mallard Ink)

5% Surfynol 104 acetylenic alcohol nonionic surfactant (Air Products and Chemicals)

1% propylene glycol (Bayer)

The above materials are combined in the order listed while mixing with low shear at room temperature for about fifteen minutes prior to using the resulting ink. Prior to using the ink after extended storage, the ink should be mixed as some settling can occur, particularly if high density pigments are contained in the ink.

A polycarbonate progressive lens is washed with an aqueous detergent solution at 125F containing 1.0 percent by weight anionic detergent in water. The lens is dried using air knives in conjunction with forced warm air. The lens is treated with corona discharge from a Multidyne corona treating unit from Softal 3DT. The ink is then applied to the lens surface to provide the progressive marking with a PI/290-A2 pad printing machine from Printing International. The ink is subsequently dried at ambient conditions of about 40% relative humidity and about 72F.

The result is a printed image with very good print quality that is readable by automated inspection equipment, excellent adhesion, no loss of markings during handling, supremely easy removal of the mark by 2-propanol or aqueous anionic detergent, and no ghost image after the mark is removed even if the lens is subsequently processed by tinting or the application of an antireflective coating.

It is thus showed that the use of the inventive ink over the commercially available solventborne inks, in conjunction with the process of the present invention, offers numerous advantages, including lower cost, decreased flammability, reduced toxicity, minimized odors, faster dry, less smudging, greater line speed, easier cleanup, greater adhesion, and the elimination of any potential for ghosting.

While only certain presently preferred embodiments of the present invention have been described in detail, as will be apparent for those skilled in the art, certain changes and modifications can be made in an embodiment without departing from the scope of the present invention as defined by the following claims.

What is claimed is:

1. A waterborne ophthalmic marking ink comprising, by weight, about 40% to about 90% waterborne vehicle and about 10% to about 60% coloring agent.

2. A waterborne ophthalmic marking ink as in claim 1 wherein the vehicle contains, by weight, about 30% to about 70% polymeric binder, 0.1% to about 10% surfactant, 1% to about 30% coupling tail solvent, 0.1% to about 20% neutralizing base, and about 10% to 50% water.

3. A waterborne ophthalmic marking ink as in claim 2, wherein the vehicle is based on an emulsion prepared from monomers selected from a group consisting of acrylic, methacrylic, styrene, vinyl toluene, and vinyl acetate.

4. A waterborne ophthalmic marking ink as in claim 2, wherein the vehicle is based on an aqueous dispersion selected from a group consisting of a polyurethane dispersion, a saturated polyester dispersion, and an alkyd dispersion.

5. A waterborne ophthalmic marking ink as in claim 2, wherein the vehicle is based on a polyurethane aqueous dispersion.

6. A waterborne ophthalmic marking ink as in claim 2, wherein the neutralizing base is selected from a group consisting of hydroxides of ammonium, potassium, sodium, lithium, or mixtures of the foregoing.

7. A waterborne ophthalmic marking ink as in claim 2, wherein the surfactant is of nonionic or anionic character.

8. A waterborne ophthalmic marking ink as in claim 7, wherein the surfactant is selected from a group consisting of monohydric acetylenic alcohols, dihydric acetylenic alcohols, perfluorinated surfactants, or mixtures of the forgoing.

9. A waterborne ophthalmic marking ink as in claim 1 wherein the coloring agent is a pigment selected from a group consisting of titanium oxides, chromates, zinc oxides, iron oxides, carbon black, calcium carbonate, and calcined clay.

10. A waterborne ophthalmic marking ink as in claim 1 wherein the coloring agent is a dye selected from a group consisting of condensed azo dyes, chelate azo dyes, phthalocyanines, anthraquinones, quinacridones, thioindigoids, isoindolinones, quinophthalones, and nitro dyes.

11. A process for applying a waterborne ophthalmic marking ink as in claim 1 on a lens surface, comprising steps of cleaning the lens surface with aqueous media, drying the lens surface, optionally treating the lens surface, and applying the ink on the lens surface with a pad printing mechanism.

12. A process for applying a waterborne ophthalmic marking ink as in claim 11, wherein the lens surface is treated with corona discharge.

13. An ophthalmic lens whereon a waterborne ophthalmic marking ink as in claim 1 is applied for the purpose of marking.

14. An ophthalmic lens ink comprising:
a waterborne coloring vehicle;
a coloring agent carried within said coloring vehicle;
said coloring vehicle including a surfactant and a coupling tail solvent sufficient to wet and adhere said ink to said ophthalmic lens ink to an ophthalmic lens.

15. An ophthalmic lens ink according to claim 14, wherein said surfactant is present within said coloring vehicle within the range of about 0.1% to about 10%, by weight, of said coloring vehicle.

16. An ophthalmic lens ink according to claim 14, wherein said coupling tail solvent is present within said coloring vehicle within a range of about 1% to about 30%, by weight, of said coloring vehicle.
